(19) United States
(12) Patent Application Publication
(10) Pub. No.: US 2025/0012335 A1
(43) Pub. Date: Jan. 9, 2025

(54) FRICTION UNIT FOR A BRAKE, BRAKE CALIPER, AND BRAKE FOR A VEHICLE

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/385,098

(22) Filed: Oct. 30, 2023

(30) Foreign Application Priority Data
Jul. 3, 2023 (DE) 102023117451.7

(51) Int. Cl. F16D 65/097

(52) U.S. Cl. CPC F16D 65/0977

(57) ABSTRACT

A friction unit for a brake of a vehicle includes a support plate or backing plate, a friction pad disposed on the support plate and including a guide recess that extends between a friction surface of the friction pad and the support plate, a column shaped distance element movably guided in the guide recess of the friction pad, and a spring that, with a first end, contacts the support plate and, with a second end, contacts the distance element.

### CROSS-REFERENCE TO RELATED APPLICATION

This application claims the benefit of German Patent Application No. 102023117451.7, filed on Jul. 3, 2023 in the German Patent Office (DPMA), the disclosures of which are incorporated herein by reference in its entirety.

### BACKGROUND

### 1. Technical Field

The present invention relates to friction unit for a brake, a brake caliper, and to a brake for a vehicle such as an automobile, a bus, a lorry, a motorcycle or similar.

### 2. Description of the Related Art

A friction brake for a vehicle, typically, includes a disc coupled to a wheel of the vehicle and a brake caliper coupled to a body or an axle of the vehicle. The brake caliper includes a carrier and a friction unit which is guided within the carrier parallel to an axis of rotation of the disc. The friction unit includes a support plate and a friction pad disposed on the support plate. For braking the wheel, the friction unit is urged towards the disc so that the friction pad is contacted to and pressed against the disc by an external brake force, which may, for example, be generated aid of hydraulic pressure, to generate a frictional force between the friction pad and the disc. When braking is finished, the friction unit is returned from the disc. However, it may occur that the friction layer and the disc remain in contact also in a non-braking state after the external brake force is removed. This may cause a residual drag moment or residual brake moment on the wheel which leads to increased energy consumption when driving the wheel.

Therefore, various measures are taken to reduce the residual brake moment. For example, KR 2003-0023253 A discloses a brake for a vehicle comprising a disc and friction unit movably guided in a carrier, wherein a friction pad of the friction unit includes a guiding hole in which a spring is mounted. The spring, on one end, rests on a support plate of the friction unit and, on the opposite end, contacts a ball received in an end portion of the guiding hole and being in contact with the disc. When the friction unit is moved in contact with the disc by application of an external brake force, the ball is received within the guiding hole and the spring is further compressed. When the external brake force is reduced, the elastic force of the spring through the ball is applied to the disc and the support plate and lifts the friction pad from the disc. As only small contact area is formed between the ball and the disc, the residual drag resulting from the contact between the ball and the disc is negligible compared to permanent contact between the friction pad and the disc.

### SUMMARY

It is one of the objects of the present invention to provide improved solutions for reducing residual brake moment in a friction brake. In particular, it is an object to find a solution which is more robust.

To this end, the present invention provides a friction unit in accordance with claim 1, a brake caliper in accordance with claim 13 and a brake in accordance with claim 15.

According to a first aspect of the invention, a friction unit for a brake of a vehicle includes a support plate or backing plate, a friction pad disposed on the support plate and including a guide recess that extends between a friction surface of the friction pad and the support plate, a column shaped distance element movably guided in the guide recess of the friction pad, and a spring that, with a first end, contacts the support plate and, with a second end, contacts the distance element.

According to a second aspect of the invention, a brake caliper for a brake of a vehicle includes a carrier and a friction unit according to the first aspect of the invention, wherein the friction unit is movably guided within the carrier along an axial direction, an wherein the distance element extends along the axial direction.

According to a third aspect of the invention, a brake for a vehicle includes a brake caliper according to the second aspect of the invention and a disc rotatable about an axis of rotation that is parallel to the axial direction, wherein the friction unit is movable towards and away from the disc so that the friction pad is enabled to contact the disc, and the spring pre-tensions the distance element in contact with the disc along the axial direction.

It is one of the ideas of the present invention to lift a friction unit of a disc by aid or a spring and a longitudinal or column shaped distance element which is guided within a guide recess of a friction pad of the friction unit and pre-tensioned by the spring towards or against the disc, wherein the spring is accommodated in the guide recess as well. The distance element longitudinally, e.g., linearly, extends between a first end and a second end. The first end is in contact with the spring, the second end is provided for being in contact with the disc. The column shaped distance element protrudes from the friction surface at least in a non-tensioned or relaxed state of the spring, e.g., by a portion adjacent to the second end. When the friction unit is moved towards the disc by an external force, the distance element moves deeper into the guide recess of the friction unit and compresses the spring. When the friction pad contacts the disc, the distance element is completely received within the guide recess. When the external force acting onto the friction unit is reduced, the elastic force spring stored in the compressed spring acts on the distance element which is in contact with the disc. Thereby, disc and the friction pad are lifted from each other.

Since the distance element is column shaped it can be guided within the guide recess with only small tolerances. One the one hand, this prevents more reliably that dust or debris enters the guide recess and blocks the spring, whereby movability of the distance element is ensured over a longer time period. On the other hand, vibrations of the distance element are reduced. This effect is even intensified by the fact that the distance element, due to its column shape, extends relatively deep into the guide recess. Thereby, a length of the spring can be reduced which helps in reducing vibrations and, additionally, helps in achieving a linear force-compression-characteristic of the spring.

Additionally, since the distance element is column shaped, the spring is positioned further away from the end of the distance element that comes into contact with the disc and becomes hot due to the frictional contact with the disc. Thereby, deterioration of the spring's elastic properties can be prevented more reliably.

Further embodiments of the present invention are subject to the dependent claims and the following description, referring to the drawings.

According to some embodiments, the friction pad may have a connection surface lying opposite to the friction surface and being coupled to the support plate, e.g., by an adhesive layer, wherein the friction pad has a pad thickness measured between the friction surface and the connection surface, and wherein a length of the distance element lies within a range between 75% and 105%, preferably between 80% and 90% of the pad thickness. Optionally, the length of the distance element may also lie within a range between 75% and 90% of the pad thickness. That is, the distance element may have a length of at least three quarters of the thickness of the friction pad through which the guide recess extends. Thereby, the vibrations of the distance element can be further reduced. Likewise, dust and particles are even more reliably prevented from getting to the spring. It should be noted that the distance element may optionally also be longer than the thickness of the friction pad according to some embodiments in which the support plate includes an accommodation recess in which an end portion of the distance element can be received.

According to some embodiments, the thickness of the friction pad may lie in a range between 10 mm and 15 mm.

According to some embodiments, the distance element may have a length in a range between 9 mm and 13 mm, preferably between 9.5 mm and 11 mm.

According to some embodiments, the distance element and the guide recess may comprise corresponding cross-sectional shapes. For example, the guide recess and the distance element, both, may have a circular cross-section or a polygonal cross-section. Providing the distance element and the guide recess with corresponding cross-sectional shapes helps further in preventing dust and particles from entering the guide recess.

According to some embodiments, the distance element may comprise a diameter in a range between 4 mm and 8 mm, preferably between 5 mm and 7 mm. When the distance element has no circular cross-sectional shape, the diameter may be defined as a diameter of a circle having the same area as defined by the cross-section of the distance element. Generally, irrespective of specific numeral values of the diameter, the cross-sectional area of the distance element may be dimensioned such that it is less than 1% of the area of the friction surface of the friction pad. Thereby, a residual drag moment applied to the disc as a consequence of contact between the distance element and the disc is reduced to a insignificant value.

According to some embodiments, the distance element may be made of a material having a friction coefficient with cast iron in a range between 0.05 and 0.1, preferably between 0.07 and 0.09. For example, the material may be a composition including metal particles, rubber particles, e.g., in the form of un-crosslinked fluor rubber, and a binder such as a resin, e.g., a phenolic resin. Further optionally, the material of the distance element may also include fibers such as glass fibers or similar. Generally, the material forming the distance element may comprise a certain elasticity. Thereby, damping properties of the distance element can be improved and, in turn, vibrations may be further reduced. On the other hand, a frictional force between the disc, which may be made of cast iron, and the distance element is reduced.

According to some embodiments, the distance element is elastically deformable along its longitudinal extension. That is, when the friction unit is urged towards the disc, not only the spring but also the distance element is elastically deformed so that its length between the first and second end is reduced. When an external force urging the friction unit towards the disc is reduced, the distance element expands again and applies an elastic force to the disc helping to lift the friction pad from the disc. That is, the distance element and the spring may be understood as two elastic spring elements connected in series. Thus, a total spring constant of the retraction mechanism consisting of the spring and the distance element is defined by a spring constant of the spring and a spring constant of the distance element. Optionally, the distance element may have a spring constant greater than the spring. Thereby, the spring is subject to greater deformation than the distance element. The elasticity of the distance element, which can be quantified, for example, by the spring constant, may be adjusted by the material composition of the distance element. For example, a percentage of rubber particles may be increased to increase elasticity, which means reducing the spring constant.

According to some embodiments, the support plate may include an accommodation recess formed in a contact surface facing the friction pad, wherein the spring, at least in the region of its first end, is received within the accommodation recess. The friction pad, with its connection surface facing away from the friction surface is attached to the contact surface of the support plate, e.g., by aid of an adhesive. In the contact surface of the support plate an accommodation recess is formed which may be positioned coaxial with the guide recess. Optionally, the accommodation recess may comprise a diameter greater than the diameter of the guide recess. Alternatively, the diameter of the guide recess and the accommodation recess may be equal to each other. The spring, in its non-tensioned or relaxed state, may be partially or completely received within the accommodation recess. The accommodation recess allows to place the spring even further away from the tip of the distance element which is in contact with the disc. Thereby, the spring is even better protected against heat and debris.

According to some embodiments, the spring, in a non-tensioned state, protrudes from the contact surface of the support plate into the guide recess of the friction pad by a partial length lying in a range between 5% and 50% of its total length. For example, the spring may protrude into the guide hole by a length between 0.2 mm and 3 mm. That is, it may be provided that the spring protrudes from the accommodation recess, however, at least half of the length of the spring is received in the accommodation recess. Thereby, a compact configuration is realized while the spring is still placed distanced to the opening of the friction surface of the friction pad and to the tip of the distance element which is in contact with the disc.

According to some embodiments, the spring, in a non-tensioned state, protrudes into the guide recess by a length being equal to or smaller than 50% of a total length of the guide recess. That is, irrespective of providing an accommodation recess, the spring may be dimensioned such that it does not occupy more than half of the length of the guide recess in a non-tensioned state. Thereby, a compact configuration is realized while the spring is still placed distanced to the opening of the friction surface of the friction pad and to the tip of the distance element which is in contact with the disc

According to some embodiments, the spring is a coil compression spring, a leaf spring, a disc spring, or an elastic block, e.g., made of a rubber material or a similar elastic material.

According to some embodiments, the friction pad includes a base layer coupled to the support plate, and a friction layer disposed on the base layer, wherein a surface of the friction layer facing away from the base layer forms the friction surface of the friction pad, and wherein the guide recess extends from the surface of the friction layer completely through the friction pad. For example, the base layer or underlayer may be made of the same material as the distance element as described above. The friction layer may be made of a material composition including metal components, such as copper, brass, iron or similar, and at least one of a plastic material, a silicone material and fibers such as glass fibers.

According to some embodiments, the brake caliper may further comprise an actuator arranged and configured to move the friction unit along the axial direction. The actuator may, for example, be a piston. The piston may be driven hydraulically, electrically, by means of electromagnetic force or in a different manner. In particular, the actuator may be displaceable along the axial direction.

The features and advantages described herein with respect to one aspect of the invention are also disclosed for the other aspects and vice versa.

With respect to directions and axes, in particular, with respect to directions and axes concerning the extension or expanse of physical structures, within the scope of the present invention, an extent of an axis, a direction, or a structure “along” another axis, direction, or structure includes that said axes, directions, or structures, in particular tangents which result at a particular site of the respective structure, enclose an angle which is smaller than 45 degrees, preferably smaller than 30 degrees and in particular preferable extend parallel to each other.

With respect to directions and axes, in particular with respect to directions and axes concerning the extension or expanse of physical structures, within the scope of the present invention, an extent of an axis, a direction, or a structure “crossways”, “across”, “cross”, or “transversal” to another axis, direction, or structure includes in particular that said axes, directions, or structures, in particular tangents which result at a particular site of the respective structure, enclose an angle which is greater or equal than 45 degrees, preferably greater or equal than 60 degrees, and in particular preferable extend perpendicular to each other.

### BRIEF DESCRIPTION OF THE DRAWINGS

For a more complete understanding of the present invention and advantages thereof, reference is now made to the following description taken in conjunction with the accompanying drawings. The invention is explained in more detail below using exemplary embodiments, which are specified in the schematic figures of the drawings, in which:

FIG. 1 schematically illustrates a cross-sectional view of a brake according to an embodiment of the invention.

FIG. 2 schematically illustrates cross-sectional views of friction units according to an embodiment of the invention together with a disc of a brake according to an embodiment of the invention.

FIG. 3 shows a detailed view of the area marked by letter Z in FIG. 2.

FIG. 4 shows a partial cross-sectional view of a friction unit according to a further embodiment of the invention.

FIG. 5 shows the friction unit of FIG. 2 in a state in which a friction layer of the friction unit is in contact with the disc of the brake;

FIG. 6 shows a plan view of a friction unit according to an embodiment of the invention.

FIG. 7 shows a plan view of a friction unit according to a further embodiment of the invention.

FIG. 8 shows a plan view of a friction unit according to a further embodiment of the invention.

FIG. 9 shows a plan view of a friction unit according to a further embodiment of the invention.

### DETAILED DESCRIPTION OF EMBODIMENTS

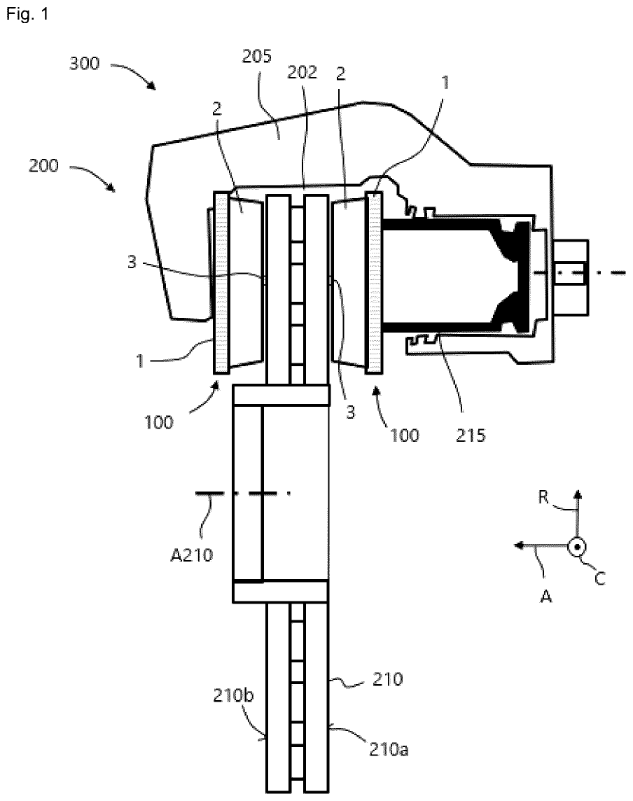

FIG. 1 schematically shows a brake 300 for a vehicle. The brake 300 may be employed, for example, in an automobile, a bus, a lorry, a motorcycle or similar. As schematically shown in FIG. 1, the brake 300 is realized as a disc brake and includes a brake caliper 200 and a disc 210.

The disc 210 will not be described in detail below. Generally, the disc 210 may have a circular shape and includes opposite friction surfaces 210a, 210b. The disc 210, in particular, the friction surfaces 210a, 210b may be made of cast iron. The disc 210 is rotatable about a rotational axis A210. For example, the disc 210 may be coupled to a wheel (not shown) of the vehicle.

The brake caliper 200 is only shown in a simplified and schematic manner in FIG. 1. As shown, the brake caliper 200 comprises a carrier 205, a pair of friction units 100, and at least one actuator 215. As further shown in FIG. 1, the carrier 205 defines a passage 202 through which the disc 210 extends. The friction units 100 are positioned on opposite sides of the passage 202 and are coupled to the carrier 205, for example, via respective clips (not shown). Generally, at least one of the friction units 100 is coupled to the carrier 205 such that it is movable by the actuator 215 along an axial direction A to come into contact with the friction surface 210a, 210b of the disc 210. The actuator 215, as exemplarily shown in FIG. 1, may be a hydraulic piston. For example, the actuator may be coupled to a hydraulic line which is connected to a main brake cylinder (not shown). The main brake cylinder may be actuated by a pedal or a lever, optionally, in concert with a brake force booster.

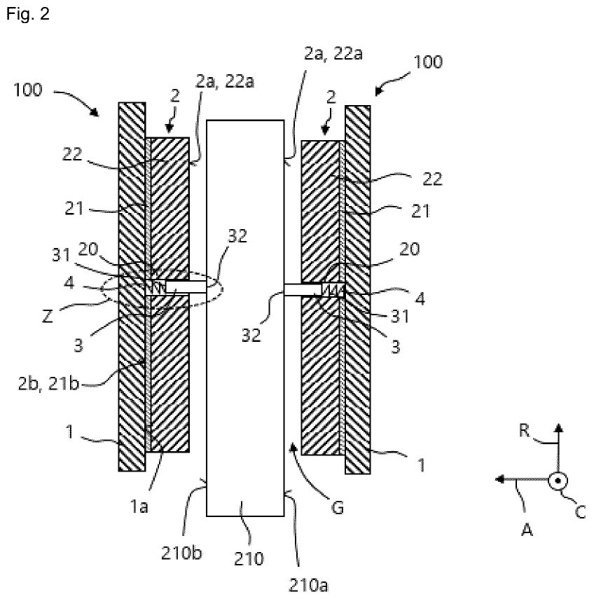

In the example of FIG. 1, the carrier 205 may be mounted to a structure of the vehicle, e.g., to an axle (not shown), so as to be movable along the axial direction A. Thereby, if the actuator 215 moves the one friction unit 100 into contact with the friction surface 210a of the disc 210, an axial displacement of the carrier 205 takes place which moves the other friction unit 100 into contact with the opposite friction surface 210b of the disc 210. Consequently, a frictional force between the friction units 100 and the disc 210 is generated which brakes the disc 210. A movement of the actuator 215 in the opposite direction, generally, causes the friction units 100 to be lifted from the friction surfaces 210a, 210b. However, since a gap G (FIG. 2) between the respective friction unit 100 and the respective friction surface 210a, 210b is dimensioned small, it might occur that the friction unit 100 remains in contact with the respective friction surface 210a, 210b even after the actuation force generated by the actuator is taken away. To avoid this, a distance element 3 and a spring 4 are provided to urge the friction unit 100 away from the disc 210 in the axial direction A as will be explained in detail below.

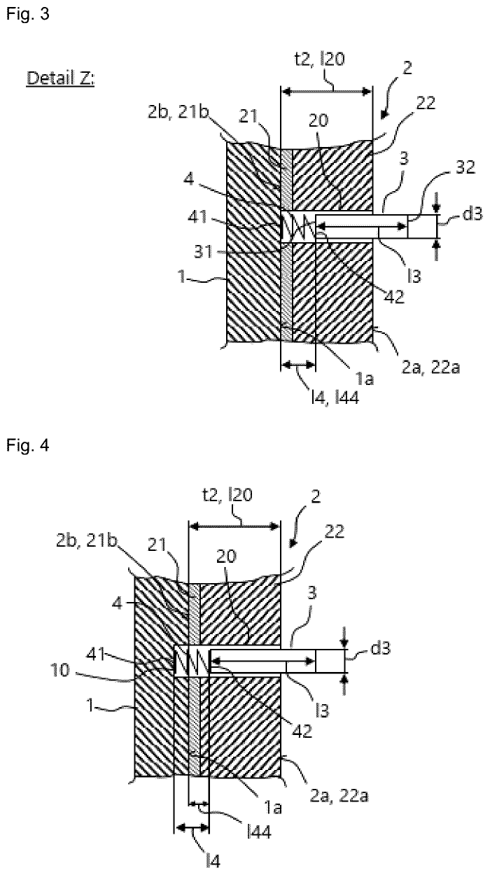

FIG. 2 shows a simplified and schematic cross-sectional view of the friction units 100 and the brake disc 210 positioned, with respect to the axial direction A, between the friction units 100. FIG. 3 shows a detailed view of the area marked by letter Z in FIG. 2.

As schematically shown in FIG. 2, each friction unit 100 comprises a support plate 1, a friction pad 2, a distance element 3, and a spring 4.

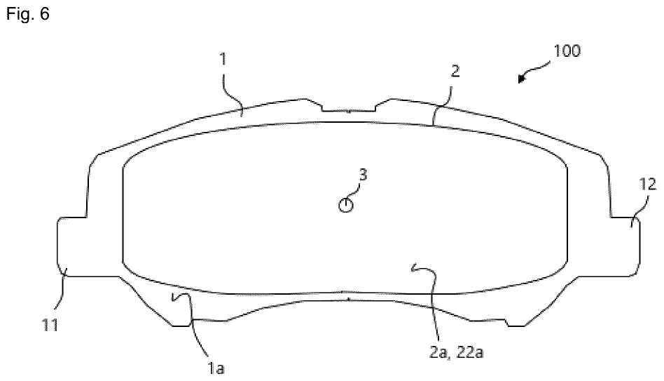

The support plate 1 is a generally plate shaped part having an areal expanse as exemplarily shown in FIGS. 6 to 9. As shown in FIG. 2, the support plate 1 comprises a connection surface 1a which, as exemplarily shown, may be planar. The support plate 1, optionally, may comprise guide pieces 11, 12 that are formed by lateral protrusions as shown in FIG. 6, for example. The guide pieces 11, 12 may protrude into respective guide tracks (not shown) of the carrier 205 of the brake caliper 200 extending along the axial direction A, so that the friction unit 100 is axially guided within the carrier 205. The support plate 1 may be made of a rigid material such as a metal material or a fiber reinforced plastic material, for example.

As exemplarily shown in FIG. 2, the friction pad 2 may comprise a base layer 21 and a friction layer 22.

The base layer 21 and the friction layer 22 are coupled or joined with each other. The base layer 21 may include a surface 21b forming a connection surface 2b of the friction pad 2 that is coupled or joined to the connection surface 1a of the support plate 1, e.g., by means of an adhesive layer (not shown). A surface 22a of the friction layer 22 oriented opposite to the surface 21b of the base layer 21 forms a friction surface 2a of the friction pad 2.

As further shown in FIG. 2, the friction pad 2 includes a guide recess 20. The guide recess 20 extends between the friction surface 2a and the contact surface 2b of the friction pad 2. Hence, the guide recess 20 forms a through hole extending through the friction pad 2. As shown in FIG. 2, the guide recess 20 extends completely through the friction layer 22 and the base layer 21. The guide recess 20 may comprise a circular cross-section. Alternatively, the guide recess 20 may, for example, comprise a polygonal cross-section. A length 120 of the guide recess 20 may correspond to the thickness t2 of the friction pad 2. As shown in FIG. 4, the support plate 1 may optionally include an accommodation recess 10 formed in the contact surface 1a. The accommodation recess 10 may be positioned coaxial with the guide recess 20.

Optionally, the accommodation recess 10 may comprise the same diameter as the guide recess 20 as exemplarily shown in FIG. 4. Alternatively, the accommodation recess 10 may comprise the greater diameter as the guide recess 20. The accommodation recess 10 provides additional space in addition to the length 120 of the guide recess 20.

Referring to FIG. 3, the friction pad 2 may comprise a total thickness t2 which may lie in a range between 10 mm and 15 mm. The base layer 21 may have a smaller thickness than the friction layer 22. For example, a thickness of the base layer 21 may be in a range between 10% and 30% of a thickness of the friction layer 22.

The base layer 21 may be made of a substantially rigid material which, however, has a certain elasticity to be able to absorb or damp vibrations caused due to contact between the friction surface 22a of the friction layer 22 and the respective friction surface 210a, 210b of the disc 210. For example, the material of the base layer may be a composition including metal particles, rubber particles, e.g., in the form of un-crosslinked fluor rubber, and a binder such as a resin, e.g., a phenolic resin.

The friction layer 22 may be made of a friction material suitable for use in a friction brake. For example, the friction layer 22 may be made of a material composition including metal components, such as copper, brass, iron or similar, and at least one of a plastic material, a silicone material and fibers such as glass fibers.

As schematically shown in FIGS. 2 and 3, the distance element 3 is column shaped. In particular, the distance element 3 extends longitudinally between a first end 31 and a second end 32. The distance element 3 may be cylindrical element, such as a pin, for example. In this context, a “cylindrical element” is not limited to a circular cylinder but may also be a cylinder having triangular, rectangular, hexagonal or other base. A cross-section of the distance element 3, hence, may, for example, be circular or polygonal. Generally, the distance element 3 and the guide recess 20 may comprise corresponding cross-sectional shapes.

The second end 32 of the distance element 3 is provided for coming into contact with the friction surface 210a, 210b of the disc 210. Optionally, the end face forming the second end 32 may comprise a convex curvature (not shown) to decrease a contact area between the end face and the friction surface 210a, 210b of the disc 210. Alternatively, the end face may be planar or substantially planar as shown in FIG. 3.

The distance element 3 may comprise a predefined length 13 measured between its first and the second end 31, 32. The length 13 of the distance element 3 may lie in a range between 9 mm and 13 mm, optionally, between 9.5 mm and 11 mm. Generally, the length 13 of the distance element 3 may lie within a range between 75% and 105%, optionally between 80% and 90% of the pad thickness t2. A diameter d3 of the distance element 3 may lie, for example, in a range between 4 mm and 8 mm, optionally between 5 mm and 7 mm. That is, an area of the end face forming the second end 32 of the distance element 3 is significantly smaller than an area of the friction surface 2a of the friction pad 2, as schematically shown in FIGS. 6 to 9. Optionally, an area of the end face forming the second end 32 of the distance element 3 may be less than 1% of the area of the friction surface 2a of the friction pad.

The distance element 3 may be made, for example, of the same material as the base layer 21. Alternatively, the distance element 3 may be made of the same material as the friction layer 22. However, the material of the distance element 3 is not limited to these examples. Generally, the distance element 3 may be is made of a material having a friction coefficient with cast iron in a range between 0.05 and 0.1, optionally between 0.07 and 0.09. It should be noted that also other ranges of friction coefficients may be realized between the distance element 3 and the disc 210. As will be further explained below, since the area of the end face of the friction element 3 is negligible compared to the area of the friction surface 2a, contact between the distance element 3 and the disc 210 does not generate significant drag moment. Optionally, the distance element 3 may elastically deformable along its longitudinal extension so that its length 13 may change upon application of a force to the first and second ends 31, 32 of the distance element 3. For example, the distance element 3 may be compressed or stretched, at least slightly, upon application of a respective force. For example, an elasticity of the distance element may be varied by a rubber percentage or, generally, a percentage of plastic material contained in the material of the distance element.

As schematically shown in FIGS. 2 and 3, the distance element 3 is positioned within and movably guided in or by the guide recess 20. That is, the distance element 3 is guided along the centerline (not indicated) of the guide recess 20 which, when the friction unit 100 is assembled in the brake caliper 200, extends parallel to the axial direction A. Hence, the distance element 3 is displaceable or movable along the axial direction A.

The spring 4, for example, may be a coil spring as schematically shown in FIGS. 2 to 4. Alternatively, spring 4 may be, for example, a leaf spring, a disc spring, or an elastic block. In particular, the spring 4 may be a compression spring. Generally, the spring 4 extends between a first end 41 and a second end 42 and comprises a length l4 measure between the first and the second end 41, 42. When a force is applied to the spring 4 to compress the spring 4, the length l4 is decreased and force acts against a rection force generated by the spring 4 due to its elastic properties.

As is further schematically shown in FIGS. 2 and 3, the spring 4 is accommodated in the guide recess 20. The first end 41 of the spring 4 rests against the planar connection surface 1a of the support plate 1. Alternatively, the spring 4 may rest on the bottom of the optional accommodation recess 10 formed in the connection surface 1a of the support plate 1, as exemplarily shown in FIG. 4. The second end 42 of the spring 4 is in contact with the first end 31 of the distance element 3. As exemplarily shown in FIGS. 3 and 4, the spring 4 and the distance element 3 may be dimensioned such that the distance element 3 protrudes from the friction surface 2a of the friction pad 2 at least in a non-tensioned state of the spring 4.

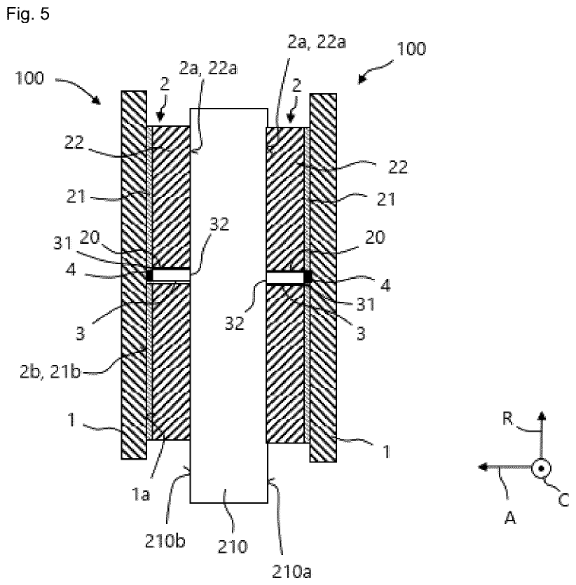

As schematically shown in FIG. 2, the spring 4 urges or pre-tensions the distance element 3 in contact with the disc 210 along the centerline of the guide recess 20. As visible in FIG. 2, the spring 4 tensions the distance element 3 such that the second end 32 of the distance element 3 is in contact with the respective friction surface 210a, 210b of the disc 210. FIG. 5 shows a state in which the friction units 100 a moved to a position, e.g., by means of the actuator 215 (not shown in FIG. 5), in which the friction surfaces 2a of the friction pads 2 are frictional contact with the respective friction surface 210a, 210b of the disc 210 to generate a brake moment. In this position, an external force is applied to the friction unit 100 that presses the friction unit 100 against the disc 210, e.g., by means of the actuator 215. As visible in FIG. 5, in this state, the distance element 3 is completely positioned in the guide recess 20 and the end face forming the second end 32 is flush with the friction surface 2a of the friction pad 2. Further, the distance element 3 compresses the spring 4. Optionally, when the distance element 3 is elastically deformable as explained above, the distance element 3 itself is compressed, too, and has a reduced length 13 compared to a non-tensioned state. When the force applied to the friction units 100, e.g., by the actuator 215, is reduced, the reaction force of the spring 4, as it rests on the support plate 1, and, optionally, the reaction force of the distance element 3, urges the friction pad 2 and the disc 210 away from each other by applying a force to the support plate 1 and, via the distance element 3, to the disc 210. Thereby, the friction surfaces 2a, 210a, 210b of the friction pad 2 and the disc 210 are separated or lifted from each other, as shown in FIG. 2, to reduce undesired residual drag.

Since the distance element 3 is column shaped the spring 4 is placed relatively far away from the friction surface 2a of the friction pad 2 and the second end 32 of the distance element 3 which, both, become hot during frictional contact with the disc 210. Therefore, lifetime of the spring 4 can be increased. Further, the column shape of the distance element 3 helps in preventing dust other particles, that may be generated due to wear of the friction layer 22 and the disc 210, from entering the space of the guide recess 20 where the spring 4 is accommodated. Thereby, the mechanism of the spring 4 and the distance element 3 becomes more robust and functionality can be ensured over a longer time.

As already mentioned above, the spring 4 may rest against the bottom of the optional accommodation recess 10 as shown in FIG. 4. In this case, the spring 4, at least in the region of its first end 41, is received within the accommodation recess 10. Theoretically, it is possible to completely accommodate the spring 4 in its non-tensioned state within the accommodation recess 10. However, it is also possible that the spring 4, in its non-tensioned state, protrudes from the contact surface 1a of the support plate 2 into the guide recess 20 of the friction pad 2 by a partial length 144, as schematically shown in FIG. 4. The partial length, in this case, may, for example, lie in a range between 5% and 50% of the total length l4 of the spring 4 in the non-tensioned state. For example, the spring may protrude into the guide hole by a partial length 144 between 0.2 mm and 3 mm.

Irrespective of the accommodation recess 10 being present or not, the spring 4, in its non-tensioned state, may protrudes into the guide recess 20 by a length 144 being equal to or smaller than 50% of a total length 120 of the guide recess 20. Thereby, the spring 4 may be held further distanced to the friction surface 2a and the second end 32 of the distance element 3.

FIGS. 2 to 5 show cross-sectional views in which only one distance element 3 is provided per friction unit 100. As schematically shown in FIG. 5, which shows a plan view to the friction surface 2a of the friction unit 2, the distance element 3 may be positioned at a central region of the friction surface 2a. As exemplarily shown in FIG. 2, the friction surface 2a of the brake pad 2 formed by the surface 22a of the friction layer 2 may be substantially rectangular. Of course, the invention is not limited thereto and other circumferential shapes of the friction surface 2a are possible. The central region where the distance element 3 may be positioned may be the region of the center of area of the friction surface 2a.

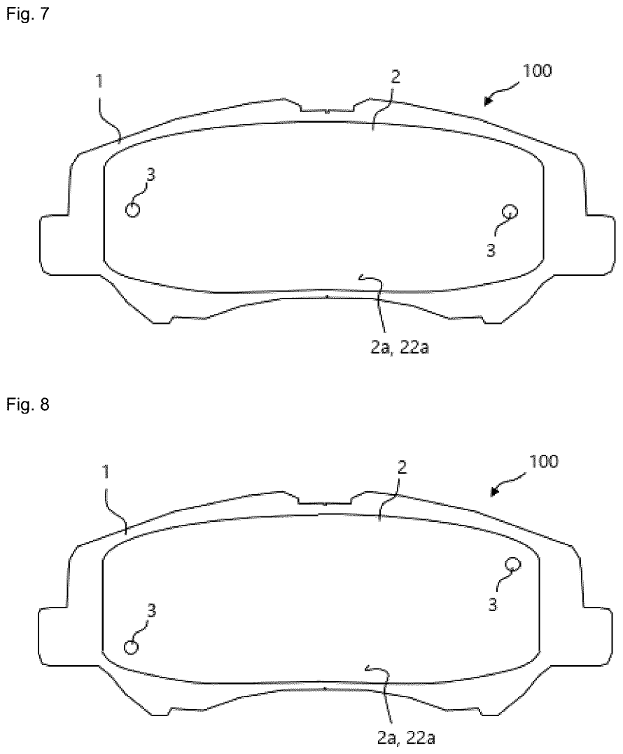

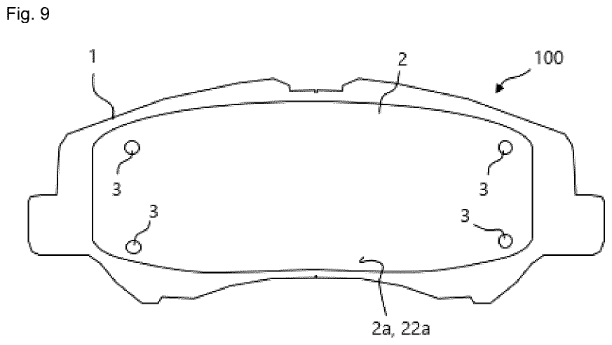

It should be noted that more than one distance element 3 may provided per friction unit 100. In this case, each distance element 3 is guided in a respective guide recess 20 in which a spring 4 is accommodated as described above. For example, FIG. 7 shows a friction unit 2 comprising two distance elements 3 positioned opposite to each other in lateral regions of the friction surface 2a of the pad 2. Alternatively, two distance elements 3 may be positioned diagonally opposite to each other in diagonally opposite corner regions of the friction surface 2a of the pad 2 as exemplarily shown in FIG. 8. FIG. 9, by way of example only, shows a friction unit 100 including four distance elements 3 each of which being positioned in one of four corner regions of the friction surface 2a of the pad 2.

As becomes apparent from FIGS. 7 to 9, also in cases where more than one distance element 3 is provided, the total area of all end faces of the distance elements 3 are negligible compared to the area of the friction surface 2a of the friction pad 2. Consequently, no significant drag moment is generated by the distance elements 3 being in contact with the disc 210 compared to drag moment generated when the friction surface 2a of the friction pad 2 is in contact with the disc 210. It should be noted that the friction pad 2 and also the distance element 3 are subject to wear. Hence, during use, the pad thickness t2 and the length 13 of the distance element 3 are reduced. The dimensions disclosed herein refer to a state before use of the friction unit 100 in a vehicle.

Although specific embodiments have been illustrated and described herein, it will be appreciated by those of at least ordinary skill in the art that a variety of alternate and/or equivalent implementations exist. It should be appreciated that the exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

What is claimed is:

1. A friction unit for a brake of a vehicle, comprising:
a support plate;
a friction pad disposed on the support plate and including a guide recess that extends between a friction surface of the friction pad and the support plate;
a column shaped distance element movably guided in the guide recess of the friction pad; and
a spring that, with a first end, contacts the support plate and, with a second end, contacts the distance element.

2. The friction unit of claim 1, wherein the friction pad has a connection surface lying opposite to the friction surface and being coupled to the support plate, wherein the friction pad has a pad thickness measured between the friction surface and the connection surface, and wherein a length of the distance element lies within a range between 75% and 105%, preferably between 80% and 90% of the pad thickness.

3. The friction unit of claim 1, wherein the distance element has a length in a range between 9 mm and 13 mm, preferably between 9.5 mm and 11 mm.

4. The friction unit of claim 1, wherein the distance element and the guide recess comprise corresponding cross-sectional shapes.

5. The friction unit of claim 1, wherein the distance element comprises a diameter in a range between 4 mm and 8 mm, preferably between 5 mm and 7 mm.

6. The friction unit of claim 1, wherein the distance element is made of a material having a friction coefficient with cast iron in a range between 0.05 and 0.1, preferably between 0.07 and 0.09.

7. The friction unit of claim 1, wherein the distance element is elastically deformable along its longitudinal extension.

8. The friction unit of claim 1, wherein the support plate includes an accommodation recess formed in a contact surface facing the friction pad, wherein the spring, at least in the region of its first end, is received within the accommodation recess.

9. The friction unit of claim 8, wherein the spring, in a non-tensioned state, protrudes from the contact surface of the support plate into the guide recess of the friction pad by a partial length lying in a range between 5% and 50% of its total length (l4).

10. The friction unit of claim 1, wherein the spring, in a non-tensioned state, protrudes into the guide recess by a length being equal to or smaller than 50% of a total length of the guide recess.

11. The friction unit of claim 1, wherein the spring is a coil compression spring, a leaf spring, a disc spring, or an elastic block.

12. The friction unit of claim 1, wherein the friction pad includes a base layer coupled to the support plate, and a friction layer disposed on the base layer, wherein a surface of the friction layer facing away from the base layer forms the friction surface of the friction pad, and wherein the guide recess extends from the surface of the friction layer completely through the friction pad.

13. A brake caliper for a brake of a vehicle, comprising:
a carrier; and
a friction unit according to claim 1 which is movably guided within the carrier along an axial direction,
wherein the distance element extends along the axial direction.

14. The brake caliper of claim 13, further comprising:
an actuator arranged and configured to move the friction unit along the axial direction.

15. A brake for a vehicle, comprising:
a brake caliper according to claim 13; and
a disc rotatable about an axis of rotation that is parallel to the axial direction;
wherein the friction unit is movable towards and away from the disc so that the friction pad is enabled to contact the disc, and
wherein the spring pre-tensions the distance element in contact with the disc along the axial direction.
